(19) United States
(12) Patent Application Publication
(10) Pub. No.: US 2021/0137036 A1
(43) Pub. Date: May 13, 2021

(54) APPARATUS FOR WATERING PLANTS

(71) Applicant: Till Engineering GmbH, Baden-Baden (DE)

(72) Inventor: Rudolf Till, Baden-Baden (DE)

(73) Assignee: Till Engineering GmbH, Baden-Baden (DE)

(21) Appl. No.: 17/149,981

(22) Filed: Jan. 15, 2021

Related U.S. Application Data
(63) Continuation of application No. PCT/EP2019/067143, filed on Jun. 27, 2019.

(51) Int. Cl. A01G 27/02; A01G 9/02; A01G 9/04; A01G 27/00

(52) U.S. Cl. CPC A01G 27/02; A01G 27/008; A01G 9/04; A01G 9/02

(57) ABSTRACT

An apparatus is disclosed for watering plants received in a non-hydroponic substrate, comprising an upwardly open planter for receiving at least one plant with non-hydroponic substrate, the planter having a planting cavity enclosed by a wall and a bottom configured for receiving a plant with the substrate, further comprising a liquid container which is at least partially integrated in the planting cavity or is designed as a separate liquid container which is inserted into the planting cavity from above or is held on an outer wall of the planting cavity, the liquid container being a container which is sealed off from the outside and which has an outlet pipe which opens into a region separated from the planting cavity at a certain distance from the bottom of the planting vessel, the separated region communicating with the planting cavity via at least one connecting opening and communicating with an outer side of the planting vessel via at least one ventilation opening, in such a manner that a liquid volume is established below the outlet tube, which is limited upwardly by a liquid level predetermined by the lower end of the outlet tube, which is located at a level above the bottom of the planting cavity, so that liquid can be discharged from the liquid volume into the substrate via the at least one connecting opening.

### CROSSREFERENCES TO RELATED APPLICATIONS

This application is a continuation of international patent application PCT/EP2019/067143, filed on Jun. 27, 2019 designating the U.S., which international patent application has been published in German language and claims priority from German patent application 10 2018 117 200.1, filed on Jul. 17, 2018. The entire contents of these priority applications are incorporated herein by reference.

### BACKGROUND

The invention relates to an apparatus for watering plants received in a non-hydroponic substrate, that is, a substrate that is not a hydroponic substrate. The substrate is thus essentially soil or soil-like substances, including sand, as opposed to hydroponic substrates, which consist of porous clay beads which are highly hygroscopic. While in hydroponic substrates or hydroponics the plants are at least partially in water with their roots, this is detrimental to plants housed in non-hydroponic substrates, as rot would then occur.

From EP 0 515 207 A1 an apparatus for watering plants is known, in which a volume of liquid is accommodated in the bottom region of a plant container. The liquid volume can be filled via a vertical filling rod which projects upwards. Within the planter, an intermediate bottom is provided which terminates above the liquid level and which communicates with the liquid volume via a tube having a non-compressible, liquid-permeable material so that liquid can rise from the liquid volume into the cavity above the intermediate bottom to the substrate in which the plant is received.

Such an embodiment is costly and requires constant monitoring. It also requires special planters.

From U.S. Pat. No. 3,534,498 A another device for watering plants is known. Here, an inner vessel is provided within a vessel in which a plant is accommodated with a soil substrate. Furthermore, a liquid container is provided within the vessel, which surrounds the inner vessel for the plant and which communicates with a liquid volume via an outlet pipe, the height of which is predetermined by the end of the outlet pipe. The liquid volume extends below the inner cavity in which the plant is received with a soil substrate. For humidification, at least one tube is provided that extends into the liquid volume and is filled with a hygroscopic material so that liquid can rise from the liquid volume into the interior vessel arranged above spaced-apart.

In one embodiment provided for hydroponic substrates, i.e., hydroponic substrates, the plant stands with its roots partially in water and the liquid volume is raised to a region approximately within the lower third or half of the planting cavity. The plant is thus directly in the water with its roots and with the clay globules surrounding it to a large extent. Here, too, the liquid level of the liquid volume is given by the lower end of the outlet pipe.

Also in the aforementioned arrangement, the planting cavity for receiving the plant with a non-hydroponic substrate, for example an earth substrate, is located at a distance above the liquid level predetermined by the lower end of the outlet tube. The at least one suction tube that is additionally necessary and comprising a hygroscopic substance projecting into the liquid volume below the planting cavity leads to a complicated structure and, in any event, to a significant increase in the size of the overall device.

### SUMMARY

In view of this, it is an object of the invention to disclose an apparatus for watering plants accommodated in a non-hydroponic substrate, allowing for a reliable and simple watering.

It is a further object of the invention, to disclose an apparatus for watering plants allowing for a water supply to a plant that is dominated substantially by the demand of the plant itself.

It is a further object of the invention, to disclose an apparatus for watering plants allowing for a water supply to a plant that can be monitored from remote.

It is a further object of the invention, to disclose an apparatus for watering plants allowing for a water supply to a plant that is provided without any pump means.

According to one aspect these and other objects are solved by an apparatus for watering plants accommodated in a non-hydroponic substrate, comprising: a planter comprising a bottom and a surrounding wall extending upwardly from said bottom thereby defining a planting cavity for receiving at least one plant within a non-hydroponic substrate;

a liquid container being sealed off against the outside and having an outlet pipe extending downwardly, said outlet pipe at its lower end forming an outlet communicating with an intermediate cavity being separated from said planting cavity;

wherein said planting cavity communicates with said intermediate cavity via at least one connecting opening;

wherein said outlet of said outlet pipe is arranged at a predetermined height above said bottom of said planting vessel so that liquid received within said liquid container is configured for establishing a liquid volume within said intermediate cavity with an upper liquid level determined by an upper end of said outlet, so as to allow a continuous wetting of a plant received allowing a discharge of liquid form said liquid volume within said intermediate cavity through said connecting opening into said planting cavity;

wherein said predetermined height is a maximum of 1% of a total height of said planting cavity.

By means of the liquid container, according to the invention, a liquid volume with a certain liquid level is set within the planting vessel in a region separated from the planting cavity, which liquid level is located at a level above the bottom of the planting cavity at a small distance.

Liquid can thus be discharged from the liquid volume into the substrate via the at least one connecting opening. Only as much liquid enters the planting cavity as is actually required by the plant. Plants that consume little water, such as cacti, orchids or the like, will take up very little liquid. In contrast, plants that have a high liquid demand will constantly take up liquid through the at least one connecting opening. Sufficient liquid is supplied by the fact that from the liquid container always so much liquid flows into the separated region that always the liquid level is kept, which is given by the lower end of the outlet pipe. From this, the plant always withdraws enough liquid via the at least one connecting opening, depending on its liquid desire, so that a moisture penetration is established in the substrate that is suitable for the plant. Depending on the liquid requirement of the plant and the substrate used (e.g. peat for high liquid requirement, or e.g. sand for low liquid requirement), a more or less large moisture penetration in the substrate is established which is in equilibrium.

In this case, the lower end of the outlet pipe opens out at only a small distance from the bottom of the planter, which is at most 5%, preferably at most 2%, further preferably at most 1% of the total height of the planting cavity above the bottom thereof.

For example, if the total height of the planting cavity is 20 cm, the liquid level is located at a maximum distance of 10 mm from the bottom of the planting cavity, preferably at a maximum distance of 2 mm, or further preferably at a maximum distance of 1 mm. Via the connecting opening, the liquid from the liquid volume is thus supplied to the interior of the planting cavity only with a very low hydrostatic pressure. Essentially, therefore, the liquid release from the liquid volume into the planting cavity is determined by how quickly the liquid is taken up by the plant. At most, there could be a liquid level within the planting cavity that is level with the liquid level within the disconnected region. However, since the at least one connecting opening has only a relatively small cross-section, from, for example, 0.5 mm², or 1 mm², or 2 mm², up to a maximum of about 10 mm², liquid from the separated liquid volume does not generally flow back into the planting cavity so quickly as to form a liquid volume at the bottom.

According to another aspect of the invention, the separated region comprises at least one vent opening in the region of the top of the planting cavity.

In this way, the afterflow of liquid from the liquid container is ensured under the effect of the external atmospheric pressure, so as to always maintain the desired level of the liquid level, which is predetermined by the lower end of the outlet pipe.

According to another aspect of the invention, the liquid container is at least partially integrated into the planter and on its upper side comprises a filling opening which can be closed by means of a first valve coupled to a second valve on the outlet tube in such a way that when the first valve is open for filling liquid, the second valve is closed, and that when the first valve is closed, the second valve is open.

In this way, a simple filling of the liquid container is made possible in a filling position, while a transition to an operating position, in which the liquid level is automatically regulated, is made possible by switching the two valves.

For this purpose, the two valves are preferably designed as sliding valves that are coupled to each other via a rod.

According to another aspect of the invention, a funnel is provided at the filling opening.

This allows easy filling of liquid into the liquid container.

According to another aspect of the invention, the liquid container is insertable with its outlet tube from above into a guide tube.

This enables a particularly simple integration of the liquid container into the planter. The necessary guidance of the liquid container is ensured by the guide tube, via which aeration is also effected at the same time in order to adjust the liquid level in the desired manner.

According to another aspect of the invention, the liquid container comprises a reservoir which is detachably connected to the outlet tube, preferably via a threaded connection.

This feature has the advantage that the liquid container can be filled in a particularly simple manner.

According to another aspect of the invention, the guide tube is held within a wall of the planter.

In this way, the liquid container with its outlet tube can be inserted directly into the guide tube in the planter.

According to another aspect of the invention, the guide tube is held on the outside of the wall of the planter and opens into a tray in which the planter is received, wherein at least one opening for the passage of liquid is provided at the bottom of the planter.

Such a variant is particularly suitable for watering plants, such as herb pots, sold in supermarkets.

According to another aspect of the invention, a level sensor is provided on the liquid container, the level sensor comprising an interface for wireless communication with an external monitoring device.

In this way, a sufficient fill level of the apparatus can be monitored in a simple manner.

According to another aspect of the invention, the interface comprises a Bluetooth interface or a WIFI interface for communication with the external monitoring device.

The external monitoring device may be, for example, a smartphone, a tablet, or a computer, wherein communication with the level sensor takes place via a software interface.

In this way, one or more irrigation devices can be conveniently monitored using an external monitoring device, such as a smartphone. Here, via a suitable app, depending on the plant type and -size, for example, the liquid requirement can be determined in advance, for example, in order to provide sufficient liquid in the event of a longer absence.

It is understood that the above-mentioned features of the invention and those to be explained below can be used not only in the respective combination indicated, but also in other combinations or on their own, without leaving the scope of the invention.

### BRIEF DESCRIPTION OF THE DRAWINGS

Further features and advantages of the invention will be apparent from the following description of preferred embodiments with reference to the drawing. In the drawings show:

FIG. 1 a first embodiment of an apparatus according to the invention for watering plants in an operating position;

FIG. 2 the apparatus according to FIG. 1 in a position for filling the liquid container;

FIG. 3 a further embodiment of an apparatus according to the invention with a liquid container which can be inserted into a guide tube inside the plant container;

FIG. 4 a further embodiment of the invention wherein a liquid container is provided which is insertable into a guide tube on the outside of a wall of the plant container, and wherein the watering is effected via a tray or a saucer in which the plant container stands; and

FIG. 5 a further variation of the embodiment according to FIG. 4, wherein a sensor with an interface for communication with an external monitoring device is provided.

### EMBODIMENTS

In FIG. 1, a first embodiment of an irrigation apparatus according to the invention is shown in cross-section and is designated overall by the numeral 10. The apparatus 10 has a pot-shaped planter of conical basic shape, with a conical planting cavity 13 having a circumferential wall 14 and a bottom 17. A liquid container 14 having a conical basic annular shape is provided in the planting cavity 13 immediately adjacent the wall 40. The lower end of the container 14 terminates at some distance above the bottom 17.

On one side of the liquid container 14, the latter is additionally extended downwardly and forms a region 15 which is separated in a liquid-tight manner with respect to the planting cavity 13. In this separated region 15, an outlet pipe 16 extends which, in the present case, is formed merely as a pipe socket which opens out on one side with an upper end 20 at a certain distance from the bottom 17 of the planting vessel 12.

The separated region 15 further communicates laterally with the outside via an upwardly extending vent, which opens to the outside at the upper end of the planting cavity 13 in a vent opening 21. Through the upper end of the outlet tube 20, which is located at a distance of, for example, 1 to 2 mm from the bottom 17 of the planter 12, a volume of liquid is established as a result of the atmospheric pressure, which is limited upwardly by a liquid level 18. The liquid level 18 is defined by the upper end of the outlet tube 20. The separated region 15 is in communication with the planting cavity 13 through a connecting opening 19, which is located at a level within the liquid volume 18. Thus, if a liquid volumen is established within the separated region 15 that is bounded upwardly by the liquid level, liquid from the liquid volume 18 enters the planting cavity 13 through the connecting opening 19.

A plant 23 is received in the planting cavity 13 with a non-hydroponic substrate 25. Thus, this is a substrate that is different from the substrate used in hydroponics. Thus, for example, it could be soil, a soil-like substance, or a mixture with sand or the like. Liquid is thus dispensed into the planting cavity 13 via the at least one connecting opening 19 from the liquid volume or intermediate cavity 18, which is established at a predetermined distance from the bottom 17 of the planting vessel 12 as a result of the pipette effect supported by the external atmospheric pressure. Only as much liquid is ever dispensed as is actually taken up by the plant 23. Thus, it is avoided that the plant 23 stands with its roots directly in the water. Likewise, it is ensured that always as much liquid flows in via the at least one connecting opening 19 as is consumed by the plant 23.

The total cross-section of the at least one connecting opening 19 is sufficiently small so that the liquid level preferably does not extend into the planting cavity 13. Depending on the liquid requirement of the plant 23 and the substrate 25 used, a more or less large moisture penetration is established in the substrate 25, which is in equilibrium.

In FIG. 1, an auxiliary means for filling the liquid container 14, which is hermetically sealed from the outside, is also shown.

A funnel 24 is provided at the upper end, which communicates with the liquid container 14 via an opening 22. A first valve 26 is provided at the top and a second valve 28 is provided at the bottom of the liquid container 14. The two valves 26, 28 are connected to each other by a rod 30 and can be operated from the top of the planter 12 by means of a handle 32. In the position shown in FIG. 1, the first valve 26 seals at the upper end with an associated cylindrical inner surface so that the cavity 14 is hermetically sealed to the outside. In this position, the lower, second valve 28 is inoperative. This means that, in this position, fluid can exit the fluid reservoir 14 directly through the outlet tube 16 and into the fluid volume 18.

If the liquid container 14 is to be filled, the rod 30 is moved downward so that a position according to FIG. 2 results, which is shown as a whole with 10′. Here, the first valve 26 is inoperative, while the second valve 28 seals within the outlet tube 16. Thus, in this position, the liquid container 14 can be filled with water from the outside via the funnel 24.

For use, the rod 30 is then pulled back up to the other position so that the first valve 26 is closed and the second valve 28 is open, resulting in the position shown in FIG. 1.

In FIG. 3, a further variation of an irrigation apparatus according to the invention is shown and designated in total by the numeral 10a. Apart from that corresponding reference numerals are used for corresponding parts.

Here, instead of a liquid container with an annular volume being completely integrated into the planter 12, a liquid container 14 is now provided which has a reservoir 36 which is connected to the outlet pipe 16 via a threaded connection 38.

In this case, the outlet tube 16 is inserted from above into a guide tube 34 which extends within the wall 40 immediately adjacent thereto.

At the lower end, a separated region or intermediate cavity 15 is again provided which communicates with the planting cavity 13 only through a connecting opening 19. The liquid container 14 is inserted into the guide tube 34 from above and held therein, so that the outlet tube 16 again opens out at a distance from the bottom 17, which is indicated by the numeral 20. A liquid level is thus established within the separated region 15, which is determined by the level of the end 20 of the outlet tube 16. Aeration takes place via the guide tube 34. Liquid escapes from the liquid volume 18 into the planting cavity 13 via the at least one connecting opening 19. Escaping liquid is replenished from the liquid within the reservoir 36 so that the level 42 of the liquid in the reservoir 36 gradually decreases.

FIG. 4 shows another variation of the invention, denoted 10b in its entirety.

The main difference from the previously described embodiment is that the guide tube 34, into which the liquid reservoir 14 with its outlet tube 16 is inserted, is not held inside the wall 40 but outside the wall 40. The guide tube 34 opens at its lower end into a pot tray 44 in which the planter 12 stands. Thus, a liquid volume 18, the level of which is predetermined by the mouth of the guide tube 34, is again established in the pot dish 44. The planter 12 has at least one connecting opening 19 in its base 17, from which liquid can pass from the intermediate liquid volume 18 into the interior of the planting cavity 13.

Another embodiment of the invention is shown in FIG. 5 and designated in total by numeral 10c. In this case, a level sensor 46 is additionally provided at the upper end of the reservoir 36. The level sensor 46 is coupled to an interface 48 via which the recorded signal is communicated, for example via Bluetooth or WIFI, via a suitable software interface and can be recorded by means of an external monitoring device 50. The external monitoring device 50 is, for example, a smartphone or a tablet that can be operated by means of a suitable app.

Thus, automatic monitoring of the liquid level can be performed on the apparatus 10c.

Depending on the design of the app, this can be used to monitor different watering apparatus simultaneously, and to provide, for example, a sufficient amount of liquid depending on the type and size of the plant to be watered, for example in case of a longer absence.

1. An apparatus for watering plants received in a non-hydroponic substrate, comprising:
a planter comprising a bottom and a surrounding wall extending upwardly from said bottom thereby defining a planting cavity for receiving at least one plant within a non-hydroponic substrate;
a liquid container being sealed off against the outside and having an outlet pipe extending downwardly, said outlet pipe at its lower end forming an outlet communicating with said planting cavity via at least one connecting opening;
wherein said outlet of said outlet pipe is arranged at a predetermined height of a maximum of 2 mm above said bottom of said planting cavity; and
wherein said connecting opening has a cross section in a range of 0.5 to 2 mm², so as to allow a continuous wetting of a plant received within said non-hydroponic substrate in said planting cavity through said connecting opening without establishing a liquid volume within said planting cavity with a liquid level of more than 2 mm.

2. The apparatus of claim 1, wherein said predetermined height of said outlet is a maximum of 1 mm above said bottom of said planting cavity.

3. The apparatus of claim 2, wherein said cross section is in a range of 0.5 to 1 mm², so as to allow a continuous wetting of a plant received within said non-hydroponic substrate in said planting cavity through said connecting opening without establishing a liquid volume within said planting cavity with a liquid level of more than 1 mm above said bottom.

4. The apparatus according to claim 1, wherein said liquid container comprises a reservoir which is detachably connected to said outlet tube.

5. The apparatus of claim 1, wherein said liquid container is secured to said planter at an outer side thereof.

6. The apparatus of claim 1, wherein said outlet pipe of said liquid container is secured to said planter so that said outlet ends within a tray, at a bottom of which said planting cavity is received.

7. The apparatus of claim 6, wherein said connecting opening is arranged at the bottom of said planting cavity.

8. The apparatus of claim 1, wherein said connecting opening is arranged at the bottom of said planting cavity.

9. The apparatus of claim 5, wherein said outlet pipe is received slidingly in a guide tube fixed to said planter.

10. The apparatus of claim 9, wherein said outlet pipe is insertable into said guide tube from above.

11. The apparatus of claim 1, wherein said outlet pipe is received slidingly in a guide tube fixed to said planter.

12. The apparatus of claim 9, wherein said guide tube comprises at least one ventilation opening leading to the outside.

13. The apparatus of claim 9, wherein said guide tube is secured to said planter so that an intermediate cavity is defined at a lower end of said outlet pipe, said intermediate cavity communicating with said planting cavity via said connecting opening.

14. The apparatus of claim 1, wherein said outlet of said outlet pipe leads into an intermediate cavity being separated from said planting cavity, said intermediate cavity being connected to said planting cavity via said connecting opening.

15. An apparatus for watering plants received in a non-hydroponic substrate, comprising:
a planter comprising a bottom and a surrounding wall extending upwardly from said bottom thereby defining a planting cavity for receiving at least one plant within a non-hydroponic substrate;
a liquid container being having an outlet pipe extending downwardly, said outlet pipe at its lower end forming an outlet leading into an intermediate cavity communicating with said planting cavity via at least one connecting opening;
wherein said liquid container is at least partially received within said planting cavity, said outlet pipe at an upper end thereof comprising a filling opening closable by a first valve, said outlet pipe further comprising an exit at a lower end thereof closable by a second valve, said first and second valves being linked to each other so that when the first valve is open for filling in liquid, the second valve is closed, and that when the first valve is closed, the second valve is open;
wherein said outlet of said outlet pipe is arranged at a predetermined height of a maximum of 10 mm above said bottom of said planting cavity; and
wherein said connecting opening has a cross section in a range of 0.5 to 10 mm², so as to allow a continuous wetting of a plant received within said non-hydroponic substrate in said planting cavity through said connecting opening without establishing a liquid volume within said planting cavity with a liquid level of more than 10 mm.

16. The apparatus of claim 15, wherein said predetermined height of said outlet is a maximum of 1 mm above said bottom of said planting cavity.

17. The apparatus of claim 15, wherein said cross section is in a range of 0.5 to 2 mm², so as to allow a continuous wetting of a plant received within said non-hydroponic substrate in said planting cavity through said connecting opening without establishing a liquid volume within said planting cavity with a liquid level of more than 1 mm above said bottom.

18. The apparatus according to claim 15, wherein said first and second valves are configured as sliding valves and are coupled to one another via a rod.

19. The apparatus according to claim 15, wherein said outlet pipe at its upper end thereof comprises a funnel for filling liquid into said liquid container when said first valve is open and said second valve is closed.

20. An apparatus for watering plants received in a non-hydroponic substrate, comprising:
a planter comprising a bottom and a surrounding wall extending upwardly from said bottom thereby defining a planting cavity for receiving at least one plant within a non-hydroponic substrate;
a liquid container being sealed off against the outside and having an outlet pipe extending downwardly, said outlet pipe at its lower end forming an outlet communicating with an intermediate cavity being separated from said planting cavity;
wherein said planting cavity communicates with said intermediate cavity via at least one connecting opening;
wherein said outlet of said outlet pipe is arranged at a predetermined height above said bottom of said planting vessel so that liquid received within said liquid container is configured for establishing a liquid volume within said intermediate cavity with an upper liquid level determined by an upper end of said outlet, so as to allow a continuous wetting of a plant received allowing a discharge of liquid form said liquid volume within said intermediate cavity through said connecting opening into said planting cavity;
wherein said predetermined height is a maximum of 1% of a total height of said planting cavity.
